(19) United States
(12) Patent Application Publication
(10) Pub. No.: US 2022/0081346 A1
(43) Pub. Date: Mar. 17, 2022

(54) METHODS FOR REDUCING CHROMIUM OXIDATION STATE DURING PROCESSING OF GLASS COMPOSITIONS

(71) Applicant: Corning Incorporated, Corning, NY (US)

(72) Inventors: Melissann Marie Ashton-Patton, Corning, NY (US); Ellen Anne King, Corning, NY (US)

(21) Appl. No.: 17/424,681

(22) PCT Filed: Jan. 15, 2020
(86) PCT No.: PCT/US20/13626

§ 371 Date: Jul. 21, 2021

Related U.S. Application Data
(60) Provisional application No. 62/798,164, filed on Jan. 29, 2019.

(51) Int. Cl. C03C 1/02; C03C 3/076; C03C 3/083; C03C 3/085; C03C 3/087; C03C 3/089; C03C 3/091; C03C 3/093; C03B 5/03; C03B 5/235

(52) U.S. Cl. CPC C03C 1/02; C03C 3/076; C03C 3/083; C03C 3/085; C03C 3/087; C03B 17/064; C03C 3/091; C03C 3/093; C03B 5/03; C03B 5/235; C03C 3/089

(57) ABSTRACT

Glass manufacturing methods disclosed herein include delivering a molten glass to a melting vessel, and melting the batch materials to produce a molten glass comprising less than about 20 ppm CrO₃. Glass articles produced by these methods are also disclosed herein.

### CROSS-REFERENCE TO RELATED APPLICATION

This application claims the benefit of priority under 35 U.S.C. § 119 of U.S. Provisional Application Ser. No. 62/798,164 filed on Jan. 29, 2019, the content of which is relied upon and incorporated herein by reference in its entirety.

### FIELD OF THE DISCLOSURE

The present disclosure relates generally to methods for reducing the oxidation state of one or more metals present in a glass composition during a glass forming process, and more particularly to methods for reducing the oxidation state of tramp metals such as chromium during melting of a glass composition.

### BACKGROUND

High-performance display devices, such as liquid crystal displays (LCDs) and plasma displays, are commonly used in various electronics, such as cell phones, laptops, electronic tablets, televisions, and computer monitors. Currently marketed display devices can employ one or more high-precision glass sheets, for example, as substrates for electronic circuit components, light guide plates (LGPs), color filters, or cover glasses, to name a few applications. Consumer demand for high-performance displays with evergrowing size and image quality requirements drives the need for improved manufacturing processes for producing large, high-quality, high-precision glass sheets.

An exemplary LCD can comprise a LGP, e.g., a glass LGP, optically coupled to a light source in an edge-lit or back-lit configuration to provide light for the display. Various optical films may be positioned on the front surface (facing the user) or back surface (facing away from the user) of the glass LGP to direct, orient, or otherwise modify the light from the light source. When light interacts with the glass LGP and optical layers, some light may be lost due to scattering and/or absorption.

Overtime, absorption of blue wavelengths (e.g., ˜450-500 nm) may undesirably result in a “color shift” or discoloration of the image displayed by the LCD. Discoloration may become accelerated at elevated temperatures, for instance, within normal LCD operating temperatures. Moreover, LED light sources may exacerbate the color shift due to their significant emission at blue wavelengths. Color shift may be less perceptible when light propagates perpendicular to the LGP (e.g., in a back-lit configuration), but may become more significant when light propagates along the length of the LGP (e.g., in an edge-lit configuration) due to the longer propagation length. Blue light absorption along the length of the LGP may result in a noticeable loss of blue light intensity and, thus, a noticeable change of color (e.g., a yellow color shift) along the propagation direction. In some instances, a color shift may be perceived by the human eye from one edge of a display to the other.

Accordingly, it would be advantageous to provide glass articles with reduced color shift, e.g., with lower absorption at blue wavelengths as compared to absorption at red wavelengths.

### SUMMARY

The disclosure relates to glass manufacturing methods comprising delivering batch materials to a melting vessel; and melting the batch materials to produce a molten glass, the molten glass comprising less than 20 ppm of CrO₃, wherein CrO₃ content in the molten glass is reduced by controlling at least one of the makeup of the batch materials and the conditions in the melting vessel to reduce the oxidation state of chromium present in the batch materials. According to various embodiments, the oxidation state of chromium can be reduced from Cr⁶⁺ to Cr³⁺. According to certain embodiments, a first ratio Cr⁶⁺/Cr³⁺ of the batch materials is greater than a second ratio Cr⁶⁺/Cr³⁺ of the molten glass. For instance, the second ratio Cr⁶⁺/Cr³⁺ of the molten glass can be less than 1. In additional embodiments, the molten glass comprises less than 10 ppm CrO₃, such as less than 1 ppm CrO₃.

According to various embodiments, controlling the makeup of the batch materials comprises selecting the glass composition to provide batch materials comprising an optical basicity of less than 0.6. In alternative embodiments, controlling the makeup of the batch materials comprises including at least one organic reducing agent in the batch materials. The organic reducing agent may be chosen, for example, from fatty acids and salts thereof. In further embodiments, controlling the melting conditions can comprise at least one of: (a) maintaining a pre-melt bath target temperature with a temperature fluctuation of +/−10° C.; and (b) maintaining an atmosphere within the melting vessel comprising an ideal gas/oxygen stoichiometric ratio with approximately 0% excess oxygen. The pre-melt bath target temperature can range, for instance, from about 1500° C. to about 1800° C. According to still further embodiments, temperature fluctuation can be controlled by at least one of: (i) using a fixed power source and allowing voltage and current to vary to maintain the pre-melt target temperature; (ii) using fixed current and allowing power and voltage to vary to maintain the pre-melt target temperature; and (iii) monitoring and controlling the bulk resistivity of the glass to maintain the pre-melt target temperature.

Further disclosed herein are glass articles produced according to the methods disclosed herein. An exemplary glass article can comprise from about 50 mol % to about 90 mol % SiO₂; from 0 mol % to about 20 mol % Al₂O₃; from 0 mol % to about 20 mol % B₂O₃; from 0 mol % to about 25 mol % RₓO; and from 0 ppm to about 20 ppm CrO₃; wherein R is chosen from one or more of Li, Na, K, Rb, and Cs and x is 2, or R is chosen from one or more of Zn, Mg, Ca, Sr, and Ba and x is 1. In various embodiments, the glass article can comprise from about 70 mol % to about 85 mol % SiO₂; from 0 mol % to about 5 mol % Al₂O₃; from 0 mol % to about 5 mol % B₂O₃; from 0 mol % to about 10 mol % Na₂O; from 0 mol % to about 12 mol % K₂O; from 0 mol % to about 4 mol % ZnO, from about 3 mol % to about 12 mol % MgO; from 0 mol % to about 5 mol % CaO; from 0 mol % to about 3 mol % SrO; from 0 mol % to about 3 mol % BaO; and from about 0.01 mol % to about 0.5 mol % SnO₂. The glass article can, in certain embodiments, comprise less than 10 ppm CrO₃ and/or a ratio Cr⁶⁺/Cr³⁺ of less than about 1.

According to non-limiting embodiments, a color shift Δy of the glass article is less than about 0.006. In certain embodiments, a first absorption coefficient of the glass article at 630 nm can be equal to or greater than a second absorption coefficient of the glass article at 450 nm. The glass article can be a glass sheet, such as a glass sheet in a display device.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be best understood when read in conjunction with the following drawings, where like structures are indicated with like reference numerals where possible and in which:

FIG. 1 illustrates an exemplary glass manufacturing system;

FIG. 2 is a graphical depiction of color shift Δy as a function of the ratio of blue to red transmission for a glass substrate;

FIG. 3 is a graphical depiction of absorption as a function of wavelength for glass substrates comprising Cr³⁺ only and both Cr³⁺ and Cr⁶⁺;

FIG. 4 is a graphical depiction of transmission as a function of wavelength for glass substrates comprising Cr³⁺ only and both Cr³⁺ and Cr⁶⁺; and

FIG. 5 is a graphical depiction of absorption as a function of optical basicity for a glass substrate.

### DETAILED DESCRIPTION

Methods

Disclosed herein are glass manufacturing methods comprising delivering batch materials to a melting vessel; and melting the batch materials to produce a molten glass, the molten glass comprising less than about 20 ppm of CrO₃, wherein CrO₃ content in the molten glass is reduced by controlling at least one of the makeup of the batch materials and the conditions in the melting vessel to reduce the oxidation state of chromium present in the batch materials.

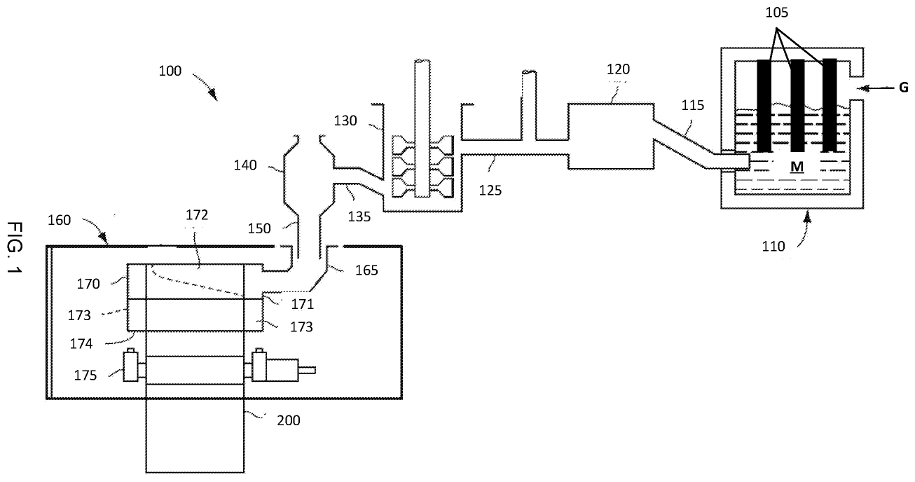

Embodiments of the disclosure are discussed below with reference to FIG. 1, which depicts an exemplary glass manufacturing system. The following general description is intended to provide only an overview of the claimed methods. Various aspects will be more specifically discussed throughout the disclosure with reference to the non-limiting embodiments, these embodiments being interchangeable with one another within the context of the disclosure.

FIG. 1 depicts a glass manufacturing system 100 for producing a glass ribbon 200. The glass manufacturing system 100 can include a melting vessel 110, a fining vessel 120, a first connecting tube 115 connecting the melting and fining vessel, a mixing vessel 130, a second connecting tube 125 connecting the fining and mixing vessels, a delivery vessel 140, a third connecting tube 135 connecting the mixing and delivery vessels, a downcomer 150, and a fusion draw machine (FDM) 160, which can include an inlet pipe 165, a forming body 170, and a pull roll assembly 175.

Glass batch materials G can be introduced into the melting vessel 110, as shown by the arrow, to form molten glass M. The melting vessel 110 can comprise, in some embodiments, one or more walls constructed from refractory ceramic bricks, e.g., fused zirconia bricks, or can be constructed from one or more precious metals, such as platinum. The melting vessel can also comprise at least one electrode 105, such as a pair of electrodes, or a plurality of electrodes, e.g., two or more pairs of electrodes.

The fining vessel 120 is connected to the melting vessel 110 by the first connecting tube 115. The fining vessel 120 comprises a high temperature processing area that receives the molten glass from the melting vessel 110 and which can remove bubbles from the molten glass. The fining vessel 120 is connected to a mixing vessel 130 by the second connecting tube 125. The mixing vessel 130 is connected to the delivery vessel 140 by the third connecting tube 135. The delivery vessel 140 can deliver the molten glass through the downcomer 150 into the FDM 160.

As described above, the FDM 160 can include an inlet pipe 165, a forming body 170, and a pull roll assembly 175. The inlet pipe 165 receives the molten glass from the downcomer 150, from which the molten glass can flow to the forming body 170. The forming body 170 can include an inlet 171 that receives the molten glass, which can then flow into the trough 172, overflowing over the sides of the trough 172, and running down the two opposing forming surfaces 173 before fusing together at the root 174 to form a glass ribbon 200. In certain embodiments, the forming body 170 can comprise a refractory ceramic, e.g., zircon or alumina ceramic. The pull roll assembly 175 can transport the drawn glass ribbon 200 for further processing by additional optional apparatuses.

For example, a traveling anvil machine (TAM), which can include a scoring device for scoring the glass ribbon, such as a mechanical or laser scoring device, may be used to separate the ribbon 200 into individual sheets, which can be machined, polished, chemically strengthened, and/or otherwise surface treated, e.g., etched, using various methods and devices known in the art. While the apparatuses and methods disclosed herein are discussed with reference to fusion draw processes and systems, it is to be understood that such apparatuses and methods can also be used in conjunction with other glass forming processes, such as slot-draw and float processes, to name a few.

Melting of the glass batch materials G can be carried out, in some embodiments, by applying an electric current to the at least one electrode 105. For instance, the at least one electrode 105 may be connected to a power supply configured to direct an electric current into the electrode and through the batch materials G, thereby releasing heat energy, for a time period sufficient to melt the batch materials to produce molten glass M. Exemplary time periods can range from about 1 hour to about 24 hours, such as from about 2 hours to about 12 hours, from about 3 hours to about 10 hours, from about 4 hours to about 8 hours, or from about 5 hours to about 6 hours, including all ranges and subranges therebetween. The electric potential may be chosen to produce heat energy sufficient to raise the temperature of the batch materials G above their melting points. Melting in the melting vessel 110 can be carried out on a batch basis, a continuous basis, or a semi-continuous basis as appropriate for any desired application. A supplemental heat source, such as one or more gas burners, may also be used in conjunction with electric heating via the electrodes.

Batch materials G appropriate for producing exemplary glasses according to the methods disclosed herein can include, for example, commercially available sands as sources for SiO₂; alumina, aluminum hydroxide, hydrated forms of alumina, and various aluminosilicates, nitrates and halides as sources for Al₂O₃; boric acid, anhydrous boric acid and boric oxide as sources for B₂O₃; periclase, dolomite (also a source of CaO), magnesia, magnesium carbonate, magnesium hydroxide, and various forms of magnesium silicates, aluminosilicates, nitrates and halides as sources for MgO; limestone, aragonite, dolomite (also a source of MgO), wolastonite, and various forms of calcium silicates, aluminosilicates, nitrates and halides as sources for CaO; and oxides, carbonates, nitrates and halides of strontium and barium. If a chemical fining agent is desired, tin can be added as SnO₂, as a mixed oxide with another major glass component (e.g., CaSnO₃), or in oxidizing conditions as SnO, tin oxalate, tin halide, or other compounds of tin known to those skilled in the art. Chemical fining agents other than SnO₂ may also be employed to obtain glass of sufficient quality for display applications. For example, exemplary glasses could employ any one or combinations of As₂CO₃, Sb₂CO₃, and halides as deliberate additions to facilitate fining.

Methods for improving the transmission of a glass substrate can be focused on reducing the concentration of tramp metals such as chromium to negligible levels (e.g., <about 20 ppm) which, in turn, can reduce absorption of blue wavelengths by the glass substrate. The improvement of glass transmission at blue wavelengths can also reduce color shift of the glass substrate. The magnitude of color shift in a glass substrate may be dictated by the shape of its absorption curve over the visible spectrum. For example, color shift can be reduced when absorption at blue wavelengths (e.g., 450 nm) is lower than absorption at red wavelengths (e.g., 630 nm).

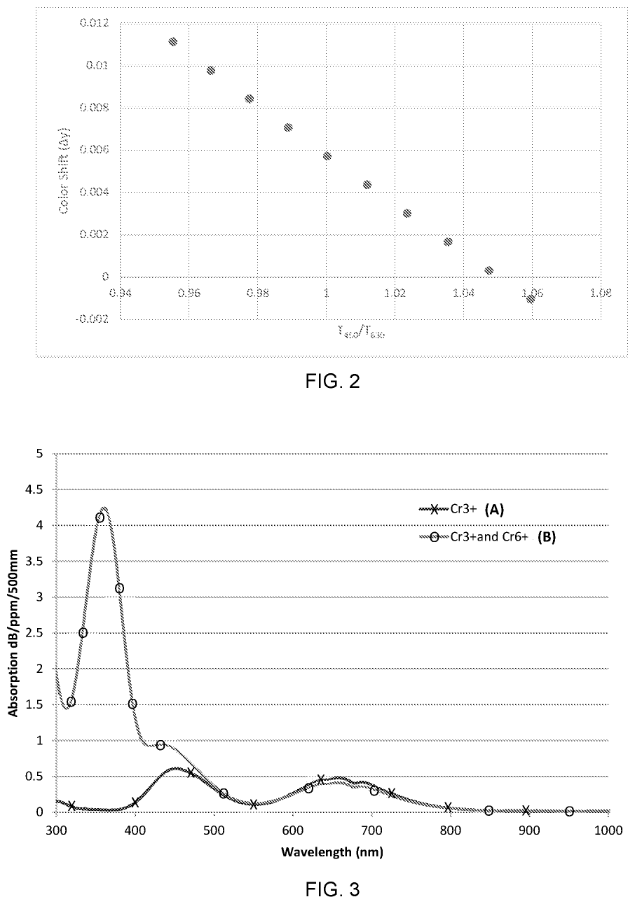

FIG. 2 demonstrates the impact of the blue/red transmission ratio on color shift for a glass substrate. As demonstrated by the plot, color shift Δy increases in a nearly linear fashion as blue (450 nm) transmission decreases relative to red (630 nm) transmission. As blue transmission approaches a value similar to that of red transmission (e.g., as the ratio approaches 1), the color shift Δy similarly approaches 0.

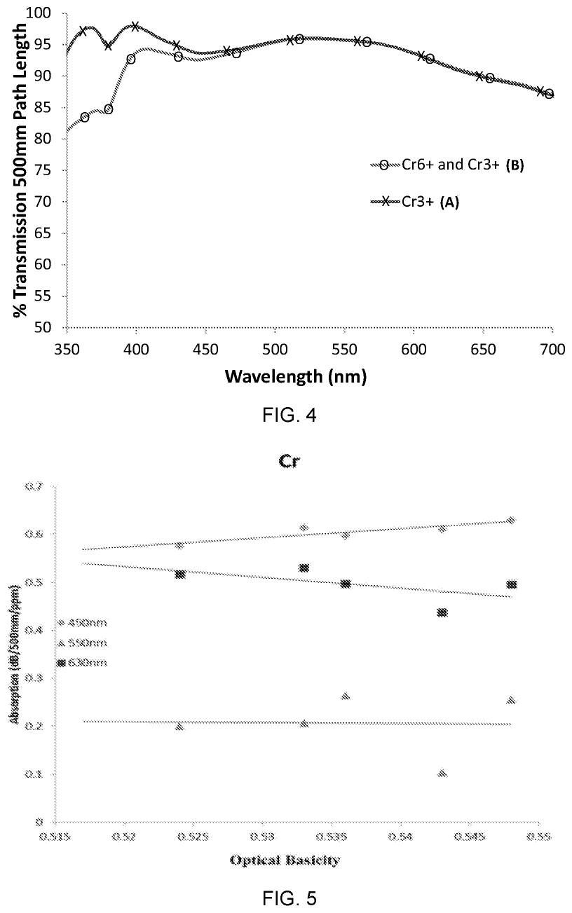

In non-limiting embodiments, the methods disclosed herein comprise controlling, i.e., reducing Cr⁶⁺ (or CrO₃) content in the molten glass. As shown in FIGS. 3-4, the presence of Cr⁶⁺ in a glass substrate can increase absorption and decrease transmission at blue wavelengths. Referring to FIG. 3, Cr³⁺ has two absorption bands, one at approximately 450 nm and one at approximately 650 nm (see Glass A). The absorption band for Cr⁶⁺ is located at approximately 360 nm (see Glass B). The Cr⁶⁺ absorption band is wide and tails into the blue wavelengths of the visible spectrum. The magnitude of width for this peak is dependent on the concentration of Cr⁶⁺ ions present in the glass substrate. In some glass compositions with high Cr⁶⁺ concentrations, the 360 nm (Cr⁶⁺) peak is so wide that it intersects the 450 nm (Cr³⁺) peak, resulting in one large absorption band, which can be detrimental to the color shift of the glass substrate. Referring to FIG. 4, the transmission of glass A (comprising Cr³⁺ only) and glass B (comprising both Cr³⁺ and Cr⁶⁺) is relatively identical at wavelength 500 nm and above. However, glass substrate B has reduced transmission at wavelengths ranging from about 350 nm to about 500 nm due to the presence of Cr⁶⁺.

According to the methods disclosed herein, the makeup of the batch materials G can thus be controlled to limit the presence of chromium in the batch materials and/or to reduce the potential for oxidation of chromium to higher oxidation states, such as Cr⁶⁺, during melting or other processing steps. Without wishing to be bound by theory, it is believed that the batch materials can be chosen to produce a base glass chemistry that can drive the chromium redox equilibrium towards a reduced state, i.e., from Cr⁶⁺ to Cr³⁺. In one exemplary embodiment, the batch materials may be chosen such that the resulting glass composition has a desirable optical basicity. As used herein the term “optical basicity” is used to refer to the behavior of the cation in the glass network of a glass composition and can be calculated, as shown in Duffy and Ingram's 1976 paper, “An Interpretation of Glass Chemistry in terms of the Optical Basicity Concept,” published in the Journal of Non-Crystalline Solids, the entirety of which is incorporated herein by reference. As shown in FIG. 5, as the optical basicity of a glass composition decreases, the absorption at blue wavelengths (e.g., 450 nm) decreases, whereas the absorption at red wavelengths (e.g., 630 nm) increases. Thus, as optical basicity decreases, the transmission of the glass substrate at blue wavelengths can increase and the color shift of the glass substrate can be reduced. According to various embodiments, the batch materials may be selected to provide a glass composition having an optical basicity of less than about 0.6, such as less than about 0.54, less than about 0.53, less than about 0.52, less than about 0.51, or less than about 0.5, including all ranges and subranges therebetween.

Reducing the Cr⁶⁺ content in the molten glass can also be achieved by modifying the batch composition with one or more additives to reduce chromium in the Cr⁶⁺ state to a lower oxidation states, such as Cr⁴⁺, Cr³⁺, or Cr²⁺ during melting. Exemplary additives can include, but are not limited to, organic reducing agents or reduced forms of certain metalloids, e.g., silicon, boron, aluminum, arsenic, antimony, or germanium. Organic reducing agents can include any compound that produce carbon upon combustion. By way of non-limiting example, organic reducing agents can include fatty acids and salts thereof. Fatty acids comprise an aliphatic chain attached to carboxylic acid, wherein the aliphatic chain can be saturated or unsaturated, and linear or branched. In certain embodiments, the fatty acids can comprise C₂-C₃₀ fatty acids, such as oleic acid, linoleic acid, palmitic acid, stearic acid, and combinations thereof. Salts of fatty acids can also be used, such as alkali or alkaline earth metal salts, e.g., sodium, potassium, lithium, magnesium, or calcium salts of fatty acids. In certain embodiments, the at least one organic reducing agent can be added to the batch materials in an amount of at least about 0.1% by weight, such as ranging from about 0.1% to about 0.25%, from about 0.25% to about 0.4%, or from about 0.5% to about 1% by weight, relative to the total weight of the batch materials, including all ranges and subranges therebetween.

The batch materials G can be melted in the melting vessel to produce molten glass M. According to various embodiments, the melting conditions and/or atmosphere within the melting vessel may be controlled to promote reduction of any chromium present in the batch materials to a lower oxidation state. As such, in various embodiments, the molten glass M may comprise less than about 20 ppm Cr⁶⁺, such as ranging from about 0.5 ppm to about 15 ppm, from about 1 ppm to about 14 ppm, from about 2 ppm to about 12 ppm, from about 3 ppm to about 10 ppm, from about 4 ppm to about 9 ppm, from about 5 ppm to about 8 ppm, or from about 6 ppm to about 7 ppm, including all ranges and subranges therebetween. According to additional embodiments, a first ratio Cr⁶⁺/Cr³⁺ of the batch materials G can be greater than a second ratio Cr⁶⁺/Cr³⁺ of the molten glass M. For instance, the second ratio Cr⁶⁺/Cr³⁺ of the molten glass M (and the resulting glass article) can be less than 1, such as ranging from about 0.05 to about 0.9, from about 0.1 to about 0.8, from about 0.2 to about 0.7, from about 0.3 to about 0.6, or from about 0.4 to about 0.5, including all ranges and subranges therebetween.

According to various embodiments, the atmosphere within the melting vessel can be controlled to maintain an ideal or approximately ideal stoichiometric gas to oxygen ratio. With little or no excess oxygen available during melting, the oxidation of chromium to higher oxidation states such as Cr⁶⁺ can be reduced or avoided by monitoring the amount of gas in proportion to an electric boost (e.g., a G/E ratio). For example, G/E ratios of between 0.20 to 0.32 or from between 0.23 to 0.29 were sufficient for embodiments described herein. Thus, excess oxygen content can be controlled by employing one or more gas burners in the melting process and tuning the consumption of oxygen during combustion to ideal or near ideal conditions using appropriate G/E ratios.

In further embodiments, melting conditions can be controlled to inhibit oxidation of chromium to higher oxidation states, such as Cr⁶⁺, e.g., by tightly controlling the pre-melt bath (PMB) temperature. As used herein, the terms “pre-melt bath” and “PMB” temperature refer to the temperature at which the batch material is melted. Without wishing to be bound by theory, it is believed that higher PMB temperatures can result in higher optical transmission at blue wavelengths due to reduced Cr⁶⁺ content in the molten glass. According to various embodiments, the PMB temperature can range from about 1500° C. to about 1800° C., such as from about 1550° C. to about 1800° C., from about 1600° C. to about 1800° C., from about 1650° C. to about 1800° C., from about 1700° C. to about 1800° C., or from about 1750° C. to about 1800° C., including all ranges and subranges therebetween.

Additionally, fluctuations in the PMB temperature can affect the Cr⁶⁺ content of the molten glass, with a 20° C. change in PMB temperature resulting in roughly 1% change in transmission. As such, the methods disclosed herein may further comprise maintaining a PMB target temperature with a temperature fluctuation of +/−10° C. Temperature fluctuation within the melting vessel can be controlled, for example, by using a fixed power source and allowing voltage and current to vary to maintain the pre-melt target temperature, by using fixed current and allowing power and voltage to vary to maintain the pre-melt target temperature, or by monitoring and controlling the bulk resistivity of the glass to maintain the pre-melt target temperature. Combinations of the above methods can also be used to achieve desired melting conditions and/or a desired Cr⁶⁺ in the molten glass.

Glass Articles

The methods disclosed herein may be used to manufacture glass articles, such as glass sheets, having advantageous optical properties. The glass articles disclosed herein can be used in a variety of electronic, display, and lighting applications, as well as architectural, automotive, and energy applications. In some embodiments, a glass sheet can be incorporated into a display device, for instance, as a LGP in a LCD.

Disclosed herein are glass articles comprising from about 50 mol % to about 90 mol % SiO₂; from 0 mol % to about 20 mol % Al₂O₃; from 0 mol % to about 20 mol % B₂O₃; from 0 mol % to about 25 mol % RₓO; and from 0 ppm to about 20 ppm CrO₃; wherein R is chosen from one or more of Li, Na, K, Rb, and Cs and x is 2, or R is chosen from one or more of Zn, Mg, Ca, Sr, and Ba and x is 1.

Embodiments of the disclosure are discussed below with reference to an exemplary glass article. The following general description is intended to provide only an overview of the claimed glass articles and their compositions. Various aspects will be more specifically discussed with reference to the non-limiting embodiments, these embodiments being interchangeable with one another within the context of the disclosure.

Glass compositions that can be processed according to the methods disclosed herein can include both alkali-containing and alkali-free glasses. Non-limiting examples of such glass compositions can include, for instance, soda lime silicate, aluminosilicate, alkali-aluminosilicate, alkaline earth-aluminosilicate, borosilicate, alkali-borosilicate, alkaline earth-borosilicate, aluminoborosilicate, alkali-aluminoborosilicate, and alkaline earth-aluminoborosilicate glasses. According to various embodiments, the methods disclosed herein can be used to produce glass sheets, such as high performance display glass substrates. Exemplary commercial glasses include, but are not limited to, EAGLE XG®, Lotus™, Willow®, Iris™, and Gorilla® glasses from Corning Incorporated.

The glass article may, in some embodiments, comprise chemically strengthened glass, e.g., ion exchanged glass. During the ion exchange process, ions within a glass sheet at or near the surface of the glass sheet may be exchanged for larger metal ions, for example, from a salt bath. The incorporation of the larger ions into the glass can strengthen the sheet by creating a compressive stress in a near surface region. A corresponding tensile stress can be induced within a central region of the glass sheet to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer which imparts a surface compressive stress.

According to various embodiments, the glass composition can comprise oxide components selected from glass formers such as SiO₂, Al₂O₃, and B₂O₃. An exemplary glass composition may also include fluxes to obtain favorable melting and forming attributes. Such fluxes can include alkali oxides (Li₂O, Na₂O, K₂O, Rb₂O and Cs₂O) and alkaline earth oxides (MgO, CaO, SrO, ZnO and BaO). In one embodiment, the glass composition can comprise 60-80 mol % SiO₂, 0-20 mol % Al₂O₃, 0-15 mol % B₂O₃, and 5-20% alkali oxides, alkaline earth oxides, or combinations thereof. In other embodiments, the glass composition of the glass sheet may not comprise B₂O₃ and may comprise 63-81 mol % SiO₂, 0-5 mol % Al₂O₃, 0-6 mol % MgO, 7-14 mol % CaO, 0-2 mol % Li₂O, 9-15 mol % Na₂O, 0-1.5 mol % K₂O, and trace amounts of Fe₂O₃, Cr₂O₃, MnO₂, Co₃O₄, TiO₂, SO₃, and/or SeO₃.

In some glass compositions described herein, SiO₂ can serve as a basic glass former. In certain embodiments, the concentration of SiO₂ can be greater than 60 mole percent to provide the glass with a density and chemical durability suitable for a display glasses or light guide plate glasses, and a liquidus temperature (liquidus viscosity), which allows the glass to be formed by a downdraw process (e.g., a fusion process). In terms of an upper limit, in general, the SiO₂ concentration can be less than or equal to about 80 mole percent to allow batch materials to be melted using conventional, high volume, melting techniques, e.g., Joule melting in a refractory melting vessel. As the concentration of SiO₂ increases, the 200 poise temperature (melting temperature) generally rises. In various applications, the SiO₂ concentration can be adjusted so that the glass composition has a melting temperature less than or equal to 1750° C. In various embodiments, the concentration of SiO₂ may range from about 60 mol % to about 81 mol %, from about 66 mol % to about 78 mol %, from about 72 mol % to about 80 mol %, or from about 65 mol % to about 79 mol %, including all ranges and subranges therebetween. In additional embodiments, the concentration of SiO₂ may range from about 70 mol % to about 74 mol %, or from about 74 mol % to about 78 mol %. In some embodiments, the concentration of SiO₂ may be about 72 mol % to 73 mol %. In other embodiments, the concentration of SiO₂ may be about 76 mol % to 77 mol %.

Al₂O₃ can also be included in the glass compositions disclosed herein as another glass former. Higher concentrations of Al₂O₃ can improve the glass annealing point and modulus. In various embodiments, the concentration of Al₂O₃ may range from 0 mol % to about 20 mol %, from about 4 mol % to about 11 mol %, from about 6 mol % to about 8 mol %, or from about 3 mol % to about 7 mol %, including all ranges and subranges therebetween. In additional embodiments, the concentration of Al₂O₃ may range from about 4 mol % to about 10 mol %, or from about 5 mol % to about 8 mol %. In some embodiments, the concentration of Al₂O₃ may be about 7 mol % to 8 mol %. In other embodiments, the concentration of Al₂O₃ may be about 5 mol % to 6 mol %, or from 0 mol % to about 5 mol % or from 0 mol % to about 2 mol %.

B₂O₃ may be included in the glass composition as both a glass former and a flux that aids melting and lowers the melting temperature. It may have an impact on both liquidus temperature and viscosity, e.g., increasing the concentration of B₂O₃ can increase the liquidus viscosity of a glass. In various embodiments, the glass compositions disclosed herein may have B₂O₃ concentrations that are equal to or greater than 0.1 mol %; however, some compositions may have a negligible amount of B₂O₃. As discussed above with regard to SiO₂, glass durability is very desirable for display applications. Durability can be controlled somewhat by elevated concentrations of alkaline earth oxides, and significantly reduced by elevated B₂O₃ content. The glass annealing point also decreases as B₂O₃ increases, so it may be helpful to keep B₂O₃ content low. Thus, in various embodiments, the concentration of B₂O₃ may range from 0 mol % to about 15 mol %, from 0 mol % to about 12 mol %, from 0 mol % to about 11 mol %, from about 3 mol % to about 7 mol %, or from 0 mol % to about 2 mol %, including all ranges and subranges therebetween. In some embodiments, the concentration of B₂O₃ may be about 7 mol % to about 8 mol %. In other embodiments, the concentration of B₂O₃ may be negligible or from 0 mol % to about 1 mol %.

In addition to the glass formers (SiO₂, Al₂O₃, and B₂O₃), the glass compositions described herein may also include alkaline earth oxides. In a non-limiting embodiment, at least three alkaline earth oxides are part of the glass composition, e.g., MgO, CaO, and BaO, and, optionally, SrO. The alkaline earth oxides can provide the glass with various properties related to melting, fining, forming, and ultimate use of the glass. In one embodiment, the (MgO+CaO+SrO+BaO)/Al₂O₃ ratio may range from 0 to 2. As this ratio increases, viscosity tends to increase more strongly than liquidus temperature, and thus it is increasingly difficult to obtain suitably high values for T₃₅ₖ−T_{liq}. Thus, in another embodiment, (MgO+CaO+SrO+BaO)/Al₂O₃ may be less than or equal to about 2. In some embodiments, the (MgO+CaO+SrO+BaO)/Al₂O₃ ratio ranges from 0 to about 1.0, from about 0.2 to about 0.6, or from about 0.4 to about 0.6, including all ranges and subranges therebetween. In further embodiments, the (MgO+CaO+SrO+BaO)/Al₂O₃ ratio is less than about 0.55 or less than about 0.4.

According to certain embodiments, the alkaline earth oxides may be effectively treated as a single compositional component because their impact upon viscoelastic properties, liquidus temperatures and liquidus phase relationships are qualitatively more similar to one another than they are to the glass forming oxides SiO₂, Al₂O₃ and B₂O₃. However, the alkaline earth oxides CaO, SrO and BaO can form feldspar minerals, notably anorthite (CaAl₂Si₂O₈) and celsian (BaAl₂Si₂O₈) and strontium-bearing solid solutions of same, but MgO does not participate in these crystals to a significant degree. Therefore, when a feldspar crystal is already the liquidus phase, a superaddition of MgO may serve to stabilize the liquid relative to the crystal and thus lower the liquidus temperature. At the same time, the viscosity curve typically becomes steeper, reducing melting temperatures while having little or no impact on low-temperature viscosities.

Adding small amounts of MgO may benefit glass melting by reducing melting temperatures and may benefit glass forming by reducing liquidus temperatures and increasing liquidus viscosity, while also preserving high annealing points. In various embodiments, the glass composition can a MgO concentration ranging from 0 mol % to about 10 mol %, from 0 mol % to about 6 mol %, from about 1 mol % to about 8 mol %, from 0 mol % to about 8.72 mol %, from about 1 mol % to about 7 mol %, from 0 mol % to about 5 mol %, from about 1 mol % to about 3 mol %, from about 2 mol % to about 10 mol %, or from about 4 mol % to about 8 mol %, including all ranges and subranges therebetween.

Without wishing to be bound by theory, it is believed that CaO present in the glass composition can produce low liquidus temperatures (high liquidus viscosities), high annealing points and moduli, and CTEs in favorable ranges for display and LGP applications. It may also contribute favorably to chemical durability, and compared to other alkaline earth oxides, it is relatively inexpensive as a batch material. However, at high concentrations, CaO can increase the density and CTE. Furthermore, at sufficiently low SiO₂ concentrations, CaO may stabilize anorthite, thus decreasing liquidus viscosity. Accordingly, in one or more embodiment, the CaO concentration can range from 0 mol % to about 6 mol %. In various embodiments, the CaO concentration of the glass composition can range from 0 mol % to about 4.24 mol %, from 0 mol % to about 2 mol %, from 0 mol % to about 1 mol %, from 0 mol % to about 0.5 mol %, or from 0 mol % to about 0.1 mol %, including all ranges and subranges therebetween. In other embodiments, the CaO concentration may range from about 7 mol % to about 14 mol % or from about 9 mol % to about 12 mol %.

SrO and BaO can both contribute to low liquidus temperatures (high liquidus viscosities). The concentration of these oxides can be selected to avoid an increase in CTE and density and a decrease in modulus and annealing point. The relative proportions of SrO and BaO can be balanced to obtain a suitable combination of physical properties and liquidus viscosity such that the glass can be formed by a downdraw process. In various embodiments, the glass composition can comprise a SrO concentration ranging from 0 mol % to about 8 mol %, from 0 mol % to about 4.3 mol %, from 0 mol % to about 5 mol %, from about 1 mol % to about 3 mol %, or less than about 2.5 mol %, including all ranges and subranges therebetween. In one or more embodiments, the BaO concentration can range from 0 mol % to about 5 mol %, from 0 mol % to about 4.3 mol %, from 0 mol % to about 2 mol %, from 0 mol % to about 1 mol %, or from 0 mol % to about 0.5 mol %, including all ranges and subranges therebetween.

In addition to the above components, the glass compositions described herein can include various other oxides to adjust various physical, melting, fining, and forming attributes of the glasses. Examples of such other oxides include, but are not limited to, TiO₂, SnO₂, MnO, V₂O₃, Fe₂O₃, ZrO₂, ZnO, Nb₂O₅, Ta₂O₅, WO₃, Y₂O₃, La₂O₃ and CeO₂ as well as other rare earth oxides and phosphates. In one embodiment, the amount of each of these oxides can be less than or equal to 2 mol %, and their total combined concentration can be less than or equal to 5 mol %. In some embodiments, the glass composition comprises ZnO in a concentration ranging from 0 mol % to about 3.5 mol %, from 0 mol % to about 3.01 mol %, or from 0 mol % to about 2 mol %, including all ranges and subranges therebetween. In other embodiments, the glass composition comprises from about 0.1 mol % to about 1.0 mol % TiO₂; from about 0.1 mol % to about 1.0 mol % V₂CO₃; from about 0.1 mol % to about 1.0 mol % Nb₂O₅; from about 0.1 mol % to about 1.0 mol % MnO; from about 0.1 mol % to about 1.0 mol % ZrO₂; from about 0.1 mol % to about 1.0 mol % SnO₂; from about 0.1 mol % to about 1.0 mol % CeO₂; and all ranges and subranges therebetween of any of the above listed metal oxides. The glass compositions described herein can also include various contaminants associated with batch materials and/or introduced into the glass by the melting, fining, and/or forming equipment used to produce the glass. The glass can also contain SnO₂ either as a result of Joule melting using tin oxide electrodes and/or through the batching of tin containing materials, e.g., SnO₂, SnO, SnCO₃, SnC₂O₂, and other like materials.

The glass compositions described herein may also can contain some alkali constituents, e.g., the glass may not be an alkali-free glasses. As used herein, an “alkali-free glass” is a glass having a total alkali concentration which is less than or equal to 0.1 mol %, where the total alkali concentration is the sum of the Na₂O, K₂O, and Li₂O concentrations. In some embodiments, the glass comprises a Li₂O concentration ranging from 0 mol % to about 8 mol %, from 1 mol % to about 5 mol %, from about 2 mol % to about 3 mol %, from 0 mol % to about 1 mol %, less than about 3.01 mol %, or less than about 2 mol %, including all ranges and subranges therebetween. In other embodiments, the glass comprises a Na₂O concentration ranging from about 3.5 mol % to about 13.5 mol %, from about 3.52 mol % to about 13.25 mol %, from about 4 mol % to about 12 mol %, from about 6 mol % to about 15 mol %, from about 6 mol % to about 12 mol %, or from about 9 mol % to about 15 mol %, including all ranges and subranges therebetween. In some embodiments, the glass comprises a K₂O concentration ranging from 0 mol % to about 5 mol %, from 0 mol % to about 4.83 mol %, from 0 mol % to about 2 mol %, from 0 mol % to about 1.5 mol %, from 0 mol % to about 1 mol %, or less than about 4.83 mol %, including all ranges and subranges therebetween.

In some embodiments, the glass compositions described herein can comprise at least one fining agent and can have one or more of the following compositional characteristics: (i) an As₂O₃ concentration of less than or equal to about 1 mol %, less than or equal to about 0.05 mol %, or less than or equal to about 0.005 mol %, including all ranges and subranges therebetween; (ii) an Sb₂O₃ concentration of less than or equal to about 1 mol %, less than or equal to about 0.05 mol %, or less than or equal to about 0.005 mol %, including all ranges and subranges therebetween; (iii) a SnO₂ concentration of less than or equal to about 3 mol %, less than or equal to about 2 mol %, less than or equal to about 0.25 mol %, less than or equal to about 0.11 mol %, or less than or equal to about 0.07 mol %, including all ranges and subranges therebetween.

Tin fining can be used alone or in combination with other fining techniques if desired. For example, tin fining can be combined with halide fining, e.g., bromine fining. Other possible combinations include, but are not limited to, tin fining plus sulfate, sulfide, cerium oxide, mechanical bubbling, and/or vacuum fining. It is contemplated that these other fining techniques can be used alone. In certain embodiments, maintaining the (MgO+CaO+SrO+BaO)/Al₂O₃ ratio and individual alkaline earth concentrations within the ranges discussed above makes the fining process easier to perform and more effective.

In various embodiments, the glass may comprise RₓO where R is Li, Na, K, Rb, Cs, and x is 2, or R is Zn, Mg, Ca, Sr or Ba, and x is 1. In some embodiments, RₓO−Al₂O₃>0. In other embodiments, 0<RₓO−Al₂O₃<15. In some embodiments, RₓO/Al₂O₃ is between 0 and 10, between 0 and 5, greater than 1, or between 1.5 and 3.75, or between 1 and 6, or between 1.1 and 5.7, and all subranges therebetween. In other embodiments, 0<RₓO−Al₂O₃<15. In further embodiments, x=2 and R₂O−Al₂O₃<15, <5, <0, between −8 and 0, or between −8 and −1, and all subranges therebetween. In additional embodiments, R₂O−Al₂O₃<0. In yet additional embodiments, x=2 and R₂O−Al₂O₃−MgO>−10, >−5, between 0 and −5, between 0 and −2, >−2, between −5 and 5, between −4.5 and 4, and all subranges therebetween. In further embodiments, x=2 and RₓO/Al₂O₃ is between 0 and 4, between 0 and 3.25, between 0.5 and 3.25, between 0.95 and 3.25, and all subranges therebetween. These ratios can affect the manufacturability of the glass article as well as determining its transmission performance. For example, glasses having RₓO−Al₂O₃ approximately equal to or larger than zero will tend to have better melting quality but if RₓO−Al₂O₃ becomes too large of a value, then the transmission curve will be adversely affected. Similarly, if RₓO−Al₂O₃ (e.g., R₂O−Al₂O₃) is within a given range as described above then the glass will likely have high transmission in the visible spectrum while maintaining meltability and suppressing the liquidus temperature of a glass. Similarly, the R₂O−Al₂O₃−MgO values described above may also help suppress the liquidus temperature of the glass.

In one or more embodiments and as noted above, exemplary glasses can have low concentrations of elements that produce visible absorption when in a glass matrix. Such absorbers include transition elements such as Ti, V, Cr, Mn, Fe, Co, Ni and Cu, and rare earth elements with partially-filled f-orbitals, including Ce, Pr, Nd, Sm, Eu, Tb, Dy, Ho, Er and Tm. Of these, the most abundant in conventional raw materials used for glass melting are Fe, Cr and Ni. Iron is a common contaminant in sand, the source of SiO₂, and is a typical contaminant as well in raw material sources for aluminum, magnesium and calcium. Chromium and nickel are typically present at low concentration in normal glass raw materials, but may be present in various ores of sand and can be controlled at a low concentration. Additionally, chromium and nickel can be introduced via contact with stainless steel, e.g., when raw material or cullet is jaw-crushed, through erosion of steel-lined mixers or screw feeders, or unintended contact with structural steel in the melting unit itself. The total concentration of iron (Fe³⁺, Fe²⁺) in some embodiments can be less than about 50 ppm, such as less than about 40 ppm, less than about 25 ppm, or less than about 15 ppm. The concentration of Ni and Cr can each be less than about 5 ppm, such as less than about 2 ppm. In further embodiments, the concentration of all other absorbers listed above may be less than about 1 ppm each. In various embodiments, the glass comprises 1 ppm or less of Co, Ni, and Cr, or alternatively, less than 1 ppm of Co, Ni, and Cr. In various embodiments, the transition elements (V, Cr, Mn, Fe, Co, Ni and Cu) may be present in the glass at a concentration of 0.1 wt % or less. In some embodiments, the total concentration of Fe (Fe³⁺, Fe²⁺) can be <about 50 ppm, <about 40 ppm, <about 30 ppm, <about 20 ppm, or <about 10 ppm. In other embodiments, Fe+30Cr+35Ni<about 60 ppm, <about 50 ppm, <about 40 ppm, <about 30 ppm, <about 20 ppm, or <about 10 ppm.

In other embodiments, the addition of certain transition metal oxides that do not cause absorption from 300 nm to 650 nm and that have absorption bands <about 300 nm can prevent network defects from forming processes and can prevent color centers (e.g., absorption of light from 300 nm to 650 nm) post UV exposure when curing ink since the bond by the transition metal oxide in the glass network will absorb the light instead of allowing the light to break up the fundamental bonds of the glass network. Thus, exemplary embodiments can include any one or combination of the following transition metal oxides to minimize UV color center formation: from about 0.1 mol % to about 3.0 mol % zinc oxide; from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % arsenic oxide; from about 0.1 mol % to about 1.0 mol % tin oxide; from about 0.1 mol % to about 1.0 mol % molybdenum oxide; from about 0.1 mol % to about 1.0 mol % antimony oxide; from about 0.1 mol % to about 1.0 mol % cerium oxide; including all ranges and subranges therebetween for any of the above listed transition metal oxides. In some embodiments, an exemplary glass can contain from 0.1 mol % to less than or no more than about 3.0 mol % of any combination of zinc oxide, titanium oxide, vanadium oxide, niobium oxide, manganese oxide, zirconium oxide, arsenic oxide, tin oxide, molybdenum oxide, antimony oxide, and cerium oxide.

In addition to the elements deliberately incorporated into exemplary glasses, nearly all stable elements in the periodic table can be present in glasses at some level, either through low levels of contamination in the raw materials, through high-temperature erosion of refractories and precious metals in the manufacturing process, or through deliberate introduction at low levels to fine tune the attributes of the final glass. For example, zirconium may be introduced as a contaminant via interaction with zirconium-rich refractories. As a further example, platinum and rhodium may be introduced via interactions with precious metals. As a further example, iron may be introduced as a tramp in raw materials, or deliberately added to enhance control of gaseous inclusions. As a further example, manganese may be introduced to control color or to enhance control of gaseous inclusions.

Hydrogen may be present in the form of the hydroxyl anion, OH—, and its presence can be ascertained via standard infrared spectroscopy techniques. Dissolved hydroxyl ions significantly and nonlinearly impact the annealing point of exemplary glasses, and thus to obtain the desired annealing point it may be beneficial to adjust the concentrations of major oxide components so as to compensate. Hydroxyl ion concentration can be controlled to some extent through choice of raw materials or choice of melting system. For example, boric acid is a major source of hydroxyls, and replacing boric acid with boric oxide can be a useful means to control hydroxyl concentration in the final glass. The same reasoning can be applied to other potential raw materials comprising hydroxyl ions, hydrates, or compounds comprising physisorbed or chemisorbed water molecules. If gas burners are used in the melting process, then hydroxyl ions can also be introduced through the combustion products from combustion of natural gas and related hydrocarbons, and thus it may be desirable to shift the energy used in melting from gas burners to electrodes to compensate. Alternatively, one might instead employ an iterative process of adjusting major oxide components so as to compensate for the deleterious impact of dissolved hydroxyl ions.

Sulfur is often present in natural gas, and likewise is a tramp component in many carbonate, nitrate, halide, and oxide raw materials. In the form of SO₂, sulfur can be a troublesome source of gaseous inclusions. The tendency to form SO₂-rich defects can be managed to a significant degree by controlling sulfur levels in the raw materials, and by incorporating low levels of comparatively reduced multivalent cations into the glass matrix. While not wishing to be bound by theory, it appears that SO₂-rich gaseous inclusions arise primarily through reduction of sulfate (SO₄²⁻) dissolved in the glass. The elevated barium concentrations of exemplary glasses appear to increase sulfur retention in the glass in early stages of melting, but as noted above, barium is desired to obtain low liquidus temperature, and hence high T₃₅ₖ−T_{liq} and high liquidus viscosity. Deliberately controlling sulfur levels in raw materials to a low level is a useful means of reducing dissolved sulfur (presumably as sulfate) in the glass. In particular, sulfur may be present in the batch materials in a concentration less than about 200 ppm, such as less than about 100 ppm.

Reduced multivalents can also be used to control the tendency of exemplary glasses to form SO₂ blisters. While not wishing to be bound to theory, these elements may behave as potential electron donors that suppress the electromotive force for sulfate reduction. Sulfate reduction can be written in terms of a half reaction such as SO₄²⁻→SO₂+O₂+2e− where e− denotes an electron. The “equilibrium constant” for the half reaction is K_{eq}=[SO₂][O₂][e−]2/[SO₄²⁻] where the brackets denote chemical activities. In some embodiments, it may be advantageous to force the reaction to create sulfate from SO₂, O₂, and 2e−. Adding nitrates, peroxides, or other oxygen-rich raw materials may help, but also may work against sulfate reduction in the early stages of melting, which may counteract the benefits of adding them in the first place. SO₂ has very low solubility in most glasses, and so is impractical to add to the glass melting process. In certain embodiments, electrons may be “added” through reduced multivalents. For example, an appropriate electron-donating half reaction for ferrous iron (Fe2+) can be expressed as 2Fe²⁺→2Fe³⁺+2e−.

This “activity” of electrons can force the sulfate reduction reaction to the left, stabilizing SO₄²⁻ in the glass. Suitable reduced multivalents include, but are not limited to, Fe²⁺, Mn²⁺, Sn²⁺, Sb³⁺, As³⁺, V³⁺, Ti³⁺, and others familiar to those skilled in the art. In each case, it may be desirable to minimize the concentrations of such components so as to avoid deleterious impact on color of the glass, or in the case of As and Sb, to avoid adding such components at a high enough level so as to complication of waste management in an end user's process.

In addition to the major oxides components of exemplary glasses, and the minor constituents noted above, halides may be present at various levels, either as contaminants introduced through the choice of raw materials, or as deliberate components used to eliminate gaseous inclusions in the glass. As a fining agent, halides may be incorporated at concentrations of about 0.4 mol % or less, though it is generally desirable to use lower amounts if possible to avoid corrosion of off-gas handling equipment. In some embodiments, the concentrations of individual halide elements are below about 200 ppm for each individual halide, or below about 800 ppm for the sum of all halide elements.

In addition to the major oxide components, minor oxide components, multivalents, and halide fining agents, it may be useful to incorporate low concentrations of other colorless oxide components to achieve desired physical, solarization, optical or viscoelastic properties. Such oxides include, but are not limited to, TiO₂, ZrO₂, HfO₂, Nb₂O₅, Ta₂O₅, MoO₃, WO₃, ZnO, In₂O₃, Ga₂O₃, Bi₂O₃, GeO₂, PbO, SeO₃, TeO₂, Y₂O₃, La₂O₃, Gd₂O₃, and others known to those skilled in the art. By adjusting the relative proportions of the major oxide components of exemplary glasses, such colorless oxides can be added to a level of up to about 2 mol % to 3 mol % without unacceptable impact to annealing point, T₃₅ₖ−T_{liq} or liquidus viscosity. For example, some embodiments can include any one or combination of the following transition metal oxides to minimize UV color center formation: from about 0.1 mol % to about 3.0 mol % zinc oxide; from about 0.1 mol % to about 1.0 mol % titanium oxide; from about 0.1 mol % to about 1.0 mol % vanadium oxide; from about 0.1 mol % to about 1.0 mol % niobium oxide; from about 0.1 mol % to about 1.0 mol % manganese oxide; from about 0.1 mol % to about 1.0 mol % zirconium oxide; from about 0.1 mol % to about 1.0 mol % arsenic oxide; from about 0.1 mol % to about 1.0 mol % tin oxide; from about 0.1 mol % to about 1.0 mol % molybdenum oxide; from about 0.1 mol % to about 1.0 mol % antimony oxide; from about 0.1 mol % to about 1.0 mol % cerium oxide; including all ranges and subranges therebetween for any of the above listed metal oxides. In some embodiments, an exemplary glass can contain from 0.1 mol % to less than or no more than about 3.0 mol % of any combination of zinc oxide, titanium oxide, vanadium oxide, niobium oxide, manganese oxide, zirconium oxide, arsenic oxide, tin oxide, molybdenum oxide, antimony oxide, and cerium oxide.

Non-limiting glass compositions can include between about 50 mol % to about 90 mol % SiO₂, between 0 mol % to about 20 mol % Al₂O₃, between 0 mol % to about 20 mol % B₂O₃, and between 0 mol % to about 25 mol % RₓO, wherein R is any one or more of Li, Na, K, Rb, Cs and x is 2, or Zn, Mg, Ca, Sr or Ba and x is 1. In some embodiments, RₓO−Al₂O₃>0; 0<RₓO−Al₂O₃<15; x=2 and R₂O−Al₂O₃<15; R₂O−Al₂O₃<2; x=2 and R₂O−Al₂O₃−MgO>−15; 0<(RₓO−Al₂O₃)<25, −11<(R₂O−Al₂O₃)<11, and −15<(R₂O−Al₂O₃−MgO)<11; and/or −1<(R₂O−Al₂O₃)<2 and −6<(R₂O−Al₂O₃−MgO)<1. In some embodiments, the glass comprises less than 1 ppm each of Co, Ni, and Cr. In some embodiments, the total Fe concentration is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. In other embodiments, the glass comprises between about 60 mol % to about 80 mol % SiO₂, between about 0.1 mol % to about 15 mol % Al₂O₃, 0 mol % to about 12 mol % B₂O₃, and about 0.1 mol % to about 15 mol % R₂O and about 0.1 mol % to about 15 mol % RO, wherein R is any one or more of Li, Na, K, Rb, Cs and x is 2, or Zn, Mg, Ca, Sr or Ba and x is 1.

In other embodiments, the glass composition can comprise from about 65.79 mol % to about 78.17 mol % SiO₂, from about 2.94 mol % to about 12.12 mol % Al₂O₃, from 0 mol % to about 11.16 mol % B₂O₃, from 0 mol % to about 2.06 mol % Li₂O, from about 3.52 mol % to about 13.25 mol % Na₂O, from 0 mol % to about 4.83 mol % K₂O, from 0 mol % to about 3.01 mol % ZnO, from 0 mol % to about 8.72 mol % MgO, from 0 mol % to about 4.24 mol % CaO, from 0 mol % to about 6.17 mol % SrO, from 0 mol % to about 4.3 mol % BaO, and from about 0.07 mol % to about 0.11 mol % SnO₂.

In additional embodiments, the glass composition can comprise an RₓO/Al₂O₃ ratio between 0.95 and 3.23, wherein R is any one or more of Li, Na, K, Rb, Cs and x is 2. In further embodiments, the glass composition may comprise an RₓO/Al₂O₃ ratio between 1.18 and 5.68, wherein R is any one or more of Li, Na, K, Rb, Cs and x is 2, or Zn, Mg, Ca, Sr or Ba and x is 1. In yet further embodiments, the glass composition can comprise an RₓO−Al₂O₃−MgO between −4.25 and 4.0, wherein R is any one or more of Li, Na, K, Rb, Cs and x is 2. In still further embodiments, the glass composition may comprise from about 66 mol % to about 78 mol % SiO₂, from about 4 mol % to about 11 mol % Al₂O₃, from about 4 mol % to about 11 mol % B₂O₃, from 0 mol % to about 2 mol % Li₂O, from about 4 mol % to about 12 mol % Na₂O, from 0 mol % to about 2 mol % K₂O, from 0 mol % to about 2 mol % ZnO, from 0 mol % to about 5 mol % MgO, from 0 mol % to about 2 mol % CaO, from 0 mol % to about 5 mol % SrO, from 0 mol % to about 2 mol % BaO, and from 0 mol % to about 2 mol % SnO₂.

In various embodiments, the glass composition can comprise from about 72 mol % to about 80 mol % SiO₂, from about 3 mol % to about 7 mol % Al₂O₃, from 0 mol % to about 2 mol % B₂O₃, from 0 mol % to about 2 mol % Li₂O, from about 6 mol % to about 15 mol % Na₂O, from 0 mol % to about 2 mol % K₂O, from 0 mol % to about 2 mol % ZnO, from about 2 mol % to about 10 mol % MgO, from 0 mol % to about 2 mol % CaO, from 0 mol % to about 2 mol % SrO, from 0 mol % to about 2 mol % BaO, and from 0 mol % to about 2 mol % SnO₂. In certain embodiments, the glass composition can comprise from about 60 mol % to about 80 mol % SiO₂, from 0 mol % to about 15 mol % Al₂O₃, from 0 mol % to about 15 mol % B₂O₃, and from about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm.

Other exemplary glass compositions are discussed in U.S. patent application Ser. No. 15/769,639, filed on Apr. 19, 2018, and entitled HIGH TRANSMISSION GLASSES, as well as International Publication No.

WO2018/183444, filed on Mar. 28, 2018, and entitled HIGH TRANSMISSION GLASSES, both of which are incorporated herein by reference in their entireties.

By way of a non-limiting example, the glass composition may comprise from about 70 mol % to about 85 mol % SiO₂; from 0 mol % to about 5 mol % Al₂O₃; from 0 mol % to about 5 mol % B₂O₃; from 0 mol % to about 10 mol % Na₂O; from 0 mol % to about 12 mol % K₂O; from 0 mol % to about 4 mol % ZnO, from about 3 mol % to about 12 mol % MgO; from 0 mol % to about 5 mol % CaO; from 0 mol % to about 3 mol % SrO; from 0 mol % to about 3 mol % BaO; and from about 0.01 mol % to about 0.5 mol % SnO₂. In other embodiments, the glass composition can comprise greater than about 80 mol % SiO₂; from 0 mol % to about 0.5 mol % Al₂O₃; from 0 mol % to about 0.5 mol % B₂O₃; from 0 mol % to about 0.5 mol % Na₂O; from about 8 mol % to about 11 mol % K₂O; from about 0.01 mol % to about 4 mol % ZnO; from about 6 mol % to about 10 mol % MgO; from 0 mol % to about 0.5 mol % CaO; from 0 mol % to about 0.5 mol % SrO; from 0 mol % to about 0.5 mol % BaO; and from about 0.01 mol % to about 0.11 mol % SnO₂. According to additional embodiments, the glass composition may be substantially free of Al₂O₃ and B₂O₃ and can comprise greater than about 80 mol % SiO₂; from 0 mol % to about 0.5 mol % Na₂O; from about 8 mol % to about 11 mol % K₂O; from about 0.01 mol % to about 4 mol % ZnO; from about 6 mol % to about 10 mol % MgO; and from about 0.01 mol % to about 0.11 mol % SnO₂. In further embodiments, the glass composition can comprise from about 72.82 mol % to about 82.03 mol % SiO₂; from 0 mol % to about 4.8 mol % Al₂O₃; from 0 mol % to about 2.77 mol % B₂O₃; from 0 mol % to about 9.28 mol % Na₂O; from about 0.58 mol % to about 10.58 mol % K₂O; from about 0 mol % to about 2.93 mol % ZnO; from about 3.1 mol % to about 10.58 mol % MgO; from 0 mol % to about 4.82 mol % CaO; from 0 mol % to about 1.59 mol % SrO; from 0 mol % to about 3 mol % BaO; and from about 0.08 mol % to about 0.15 mol % SnO₂. In still further embodiments, the glass composition may be a substantially alumina-free potassium silicate composition comprising greater than about 80 mol % SiO₂; from about 8 mol % to about 11 mol % K₂O; from about 0.01 mol % to about 4 mol % ZnO; from about 6 mol % to about 10 mol % MgO; and from about 0.01 mol % to about 0.11 mol % SnO₂.

The glass articles produced by the methods disclosed herein can, in non-limiting embodiments, have compositions including from about 0 ppm to about 20 ppm of CrO₃, such as from about 1 ppm to about 18 ppm, from about 2 ppm to about 16 ppm, from about 3 ppm to about 15 ppm, from about 4 ppm to about 14 ppm, from about 5 ppm to about 12 ppm, from about 6 ppm to about 11 ppm, from about 7 ppm to about 10 ppm, or from about 8 ppm to about 9 ppm of CrO₃, including all ranges and subranges therebetween. In other embodiments, the CrO₃ content may be less than 5 ppm, such as 1, 2, 3, or 4 ppm CrO₃. In still further embodiments, a ratio of Cr⁶⁺/Cr³⁺ in the glass article may be less than or equal to about 1, such as ranging from about 0.05 to about 0.9, from about 0.1 to about 0.8, from about 0.2 to about 0.7, from about 0.3 to about 0.6, or from about 0.4 to about 0.5, including all ranges and subranges therebetween. The glass articles disclosed herein may, in various embodiments, have any combination of any of the above-mentioned compositional features.

In some embodiments, the glass articles disclosed herein can comprise a color shift Δy less than 0.015, such as ranging from about 0.005 to about 0.015 (e.g., about 0.005, 0.006, 0.007, 0.008, 0.009, 0.010, 0.011, 0.012, 0.013, 0.014, or 0.015). In other embodiments, the glass article can comprise a color shift less than 0.008. Color shift may be characterized by measuring variation in the x and y chromaticity coordinates along the length L using the CIE 1931 standard for color measurements. For glass LGPs the color shift Δy can be reported as Δy=y(L₂)−y(L₁) where L₂ and L₁ are Z positions along the panel or substrate direction away from the source launch and where L₂−L₁=0.5 meters. Exemplary glass articles can have Δy<0.01, Δy<0.005, Δy<0.003, or Δy<0.001. According to certain embodiments, the glass article can have a light attenuation α₁ (e.g., due to absorption and/or scattering losses) of less than about 4 dB/m, such as less than about 3 dB/m, less than about 2 dB/m, less than about 1 dB/m, less than about 0.5 dB/m, less than about 0.2 dB/m, or even less, e.g., ranging from about 0.2 dB/m to about 4 dB/m, for wavelengths ranging from about 420-750 nm.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a component” includes examples having two or more such components unless the context clearly indicates otherwise.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. Moreover, “substantially similar” is intended to denote that two values are equal or approximately equal. In some embodiments, “substantially similar” may denote values within about 10% of each other, such as within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A glass manufacturing method comprising:
melting batch materials in a melting vessel to produce a molten glass, the molten glass comprising less than about 20 ppm of CrO₃;
wherein CrO₃ content in the molten glass is reduced by controlling at least one of the makeup of the batch materials or the conditions in the melting vessel to reduce the oxidation state of chromium present in the batch materials.

2. The method of claim 1, wherein the oxidation state is reduced from Cr⁶⁺ to Cr³⁺.

3. The method of claim 1, wherein a first ratio Cr⁶⁺/Cr³⁺ of the batch materials is greater than a second ratio Cr⁶⁺/Cr³⁺ of the molten glass article.

4. The method of claim 3, wherein the second ratio Cr⁶⁺/Cr³⁺ of the molten glass is less than 1.

5. The method of claim 1, wherein the molten glass comprises less than about 10 ppm of CrO₃.

6. The method of claim 1, wherein the molten glass comprises less than about 1 ppm of CrO₃.

7. The method of claim 1, wherein controlling the makeup of the batch materials comprises selecting the glass composition to provide batch materials comprising an optical basicity of less than about 0.6.

8. The method of claim 1, wherein controlling the makeup of the batch materials comprises including at least one organic reducing agent in the batch materials.

9. The method of claim 8, wherein the at least one organic reducing agent is chosen from fatty acids and salts thereof.

10. The method of claim 1, wherein controlling the melting conditions comprises at least one of:
(a) maintaining a pre-melt bath target temperature with a temperature fluctuation of +/−10° C.; or
(b) maintaining an atmosphere within the melting vessel comprising an ideal gas/oxygen stoichiometric ratio with approximately 0% excess oxygen.

11. The method of claim 10, wherein the pre-melt bath target temperature ranges from about 1500° C. to about 1800° C.

12. The method of claim 10, wherein the temperature fluctuation is controlled by at least one of:
(i) using a fixed power source and allowing voltage and current to vary to maintain the pre-melt target temperature;
(ii) using fixed current and allowing power and voltage to vary to maintain the pre-melt target temperature; or
(iii) monitoring and controlling the bulk resistivity of the molten glass to maintain the pre-melt target temperature.

13. A glass article comprising:
from about 50 mol % to about 90 mol % SiO₂;
from 0 mol % to about 20 mol % Al₂O₃;
from 0 mol % to about 20 mol % B₂O₃;
from 0 mol % to about 25 mol % RₓO; and
from 0 ppm to about 20 ppm CrO₃;
wherein R is chosen from one or more of Li, Na, K, Rb, or Cs and x is 2, or R is chosen from one or more of Zn, Mg, Ca, Sr, or Ba and x is 1.

14. The glass article of claim 13, comprising:
from about 70 mol % to about 85 mol % SiO₂;
from 0 mol % to about 5 mol % Al₂O₃;
from 0 mol % to about 5 mol % B₂O₃;
from 0 mol % to about 10 mol % Na₂O;
from 0 mol % to about 12 mol % K₂O;
from 0 mol % to about 4 mol % ZnO;
from about 3 mol % to about 12 mol % MgO;
from 0 mol % to about 5 mol % CaO;
from 0 mol % to about 3 mol % SrO;
from 0 mol % to about 3 mol % BaO; and
from about 0.01 mol % to about 0.5 mol % SnO₂.

15. The glass article of claim 13, wherein a color shift Δy of the glass article is less than about 0.006.

16. The glass article of claim 13, wherein a ratio Cr⁶⁺/Cr³⁺ of the glass article is less than about 1.

17. The glass article of claim 13, comprising less than about 1 ppm CrO₃.

18. The glass article of claim 13, wherein a first absorption coefficient of the glass article at 630 nm is greater than or equal to a second absorption coefficient of the glass article at 450 nm.

19. The glass article of claim 13, wherein the glass article is a glass sheet.

20. A display device comprising the glass sheet of claim 19.
